(19) United States
(12) Patent Application Publication
(10) Pub. No.: US 2026/0320620 A1
(43) Pub. Date: Oct. 15, 2026

(54) DYNAMIC HOST-BASED CONTROLS IN FLEET TRANSACTIONS

(71) Applicant: VISA INTERNATIONAL SERVICES ASSOCIATION, San Francisco, CA (US)

(72) Inventors: Christoffel Daniel Maurice Brummer, Foster City, CA (US); Adi Mistry, San Francisco, CA (US)

(73) Assignee: VISA INTERNATIONAL SERVICES ASSOCIATION, San Francisco, CA (US)

(21) Appl. No.: 19/646,343

(22) Filed: Apr. 13, 2026

Related U.S. Application Data
(60) Provisional application No. 63/787,485, filed on Apr. 11, 2025.
(60) Provisional application No. 63/972,607, filed on Jan. 30, 2026.

(51) Int. Cl. G06Q 20/40; G06Q 20/18

(52) U.S. Cl. CPC G06Q 20/405; G06Q 20/18

(57) ABSTRACT

Techniques for host-based controls in fleet transactions are described. In some examples, an issuer computer receives, from a resource provider computer, an authorization request message for a transaction of items between a resource provider and an entity. The authorization request message includes a flag indicating that the resource provider supports a restriction being applied to the transaction. The issuer computer reviews the authorization request message to identify the flag, identifies restrictions to be applied to the transaction, and generates an authorization response message that includes a payload based on the restrictions. The issuer transmits the authorization response message including the payload to the resource provider computer, which performs at least one of: when the payload includes prompts, receives input to the prompts and transmits a clearing message including the input to the issuer computer, or when the payload includes rules, processes the items in the transaction based on the rules.

### CROSS-REFERENCES TO RELATED APPLICATIONS

This application is a non-provisional patent application which claims the benefit of the filing date of U.S. Patent Application No. 63/787,485 filed Apr. 11, 2025, entitled “Dynamic Host-Based Controls in Fleet Transaction”; and U.S. Patent Application No. 63/972,607, filed Jan. 30, 2026, entitled “Dynamic Host-Based Fleet Controls for More than 10 Items”, which are herein incorporated by reference in their entirety for all purposes.

### BACKGROUND OF THE INVENTION

In the fleet and commercial payments industry, there is a substantial need to dynamically control and monitor purchases made with fleet cards, corporate cards, and similar payment instruments. Conventional systems achieve such control by encoding purchase restrictions and prompting requirements, such as limits on permissible goods and required entry of driver or vehicle information, directly onto physical chip cards using EMV data tags. This static, card-based approach is inflexible, where any change in business rules or prompting requirements result in the costly and environmentally detrimental reissuance of physical cards.

Furthermore, legacy systems do not support card-not-present transactions, such as those initiated through digital wallets, mobile applications, or credentials on file, which are increasingly common in fleet and commercial environments.

Existing payment network protocols and merchant terminals also limit the number of item-level details that can be transmitted in an authorization request, often capping the number of items at a fixed threshold. This constraint impedes the ability of merchants and issuers to apply sophisticated, item-level controls and real-time decisioning for large, complex transactions, which are a frequent occurrence in fleet and commercial purchases involving fuel, multiple products, and services. As a result, there is a need for a scalable, flexible, and dynamic system that enables issuers to impose and update transaction-level restrictions and prompting requirements in real time, supports both card-present and card-not-present payment scenarios, and facilitates robust item-level controls and data collection for all relevant transaction types.

### BRIEF SUMMARY OF THE INVENTION

Embodiments provide a payment transaction system that provides a fleet-based restriction to a fleet-based vehicle energy (e.g., fuel and/or electricity) purchase initiated by a fleet member at a merchant. The energy purchase may be conducted using a card-not-present transaction, such as a digital credential uploaded to a mobile application running on a user device. Contrary to the conventional transactions where a card is used for the energy purchase, the restrictions to be applied to the transaction cannot be retrieved from the card memory/chip. Accordingly, embodiments provide methods where the authorizing entity (e.g., issuer, host) can send prompts for information. For example, resource providers indicate via a flag in the incoming authorization request message, what controls they can support at their point of sale (POS). Upon checking this flag, issuers send back a set of host-based purchase restrictions in the authorization response message to override the chip-based purchase restrictions (e.g., tag ‘DF32’) or to add host-based prompting requirements. This allows an issuer to have dynamic control of the purchase and only allow the restriction they are passing back.

Embodiments also provide a payment transaction system that applies a fleet-based purchase control or restriction to purchases falling under a predetermined category (e.g., energy purchase such as fuel and/or electricity, food but not alcohol or clothing items). Embodiments allow the customer to purchase more items than conventionally allowed (e.g., more than 10 items). A resource provider computer inserts a purchase restrictions flag in the authorization request message to signal that there are more than the predetermined amount of items (e.g. more than 10 items) in the transaction, and requests the issuer to provide the host-based controls (e.g., rules or restrictions) to the resource provider so that the restrictions can be applied by the resource provider in real time, at the merchant terminal. This purchase restrictions flag may specify, for example, that the terminal supports chip-based controls, host-based controls, a combination of both, or that the transaction involves more than ten items, thereby requiring special handling. The authorization request may also include line-item data for up to ten items, formatted in accordance with ISO message conventions (such as data set 1A).

Upon receipt of the authorization request, the issuer computer inspects the purchase restrictions flag and any accompanying line-item data. The issuer computer identifies the applicable transaction rules, which may include allowed or impermissible item categories, item-level approval or denial, purchase control or restriction eligibility, and required prompts for additional information such as driver or vehicle identification or odometer readings. The issuer then generates an authorization response that may approve all, some, or none of the items in the transaction. For transactions involving more than ten items, the issuer computer's response enables the resource provider terminal to process only the permitted items in real time, with any remaining items handled separately, such as by allowing all items in clearing that are aligned with the issuer's response, payment via a different account, or declining the transaction for non-approved items.

During post-transaction clearing and settlement, the resource provider provides the full itemized list of all items in the transaction to the issuer for verification and compliance checking. According to various embodiments, the host-based controls provided to the resource provider may override the controls encoded on the chip card. In some embodiments, even if the authorization request message does not include a purchase restrictions flag, the issuer computer may respond with the host-based controls (e.g., the rules) so that the resource provider may process the items based on the host-based controls at the resource provider terminal, in real time. Yet in other embodiments, the issuer computer may respond with an authorization response message that includes only the allowed items. The user may be asked to provide a different account to purchase the impermissible items.

One embodiment includes a method. The method involves receiving, by an issuer computer of an issuer from a resource provider computer of a resource provider, an authorization request message associated with a transaction of a plurality of items between the resource provider and an entity using an account issued by the issuer. The authorization request message includes a flag indicating that the resource provider supports a restriction to be applied to the transaction. The method further involves reviewing, by the issuer computer, the authorization request message to identify the flag. The method further involves identifying, by the issuer computer, one or more restrictions to be applied to the transaction based on the flag. The method further involves generating, by the issuer computer, an authorization response message. The authorization response message includes a payload in view of the one or more restrictions. The method further involves transmitting, by the issuer computer to the resource provider computer, the authorization response message including the payload. The resource provider computer performs at least one of: when the payload includes one or more prompts, displays the one or more prompts on a terminal, receives input in response to the one or more prompts, generates a clearing message including the input in response to the one or more prompts, such that the clearing message is transmitted to the issuer computer, or when the payload includes one or more rules, processes the items in the transaction based on the one or more rules.

Another embodiment includes a method. The method involves receiving, by a resource provider computer, a request to finalize a transaction for a plurality of items using an account issued by an issuer. The method further involves generating, by the resource provider computer, an authorization request message associated with the transaction. The authorization request message includes a purchase restrictions flag. The method further involves transmitting, by the resource provider computer, the authorization request message to an issuer computer of the issuer. The method further involves receiving, by the resource provider computer from the issuer computer, an authorization response message. The authorization response message includes a payload for processing the transaction subject to one or more restrictions. The method further involves processing in real time, by the resource provider computer, the transaction based on the payload. The processing includes at least one of: when the payload includes one or more prompts, displaying the one or more prompts on a terminal, receiving input in response to the one or more prompts, generating a clearing message including the input in response to the one or more prompts, such that the clearing message is transmitted to the issuer computer, or when the payload includes one or more rules, processing the items in the transaction based on the one or more rules including determining whether each item among the plurality of items are approved for purchase based on the one or more rules.

Another embodiment includes a system comprising an issuer computer of an issuer. The issuer computer comprises one or more processors and a memory storing instructions that, when executed by the one or more processors, cause the one or more processors to perform steps. The steps include receiving, from a resource provider computer of a resource provider, an authorization request message associated with a transaction of a plurality of items between the resource provider and an entity using an account issued by the issuer. The authorization request message includes a flag indicating that the resource provider supports a restriction to be applied to the transaction. The steps further include reviewing the authorization request message to identify the flag. The steps further include identifying one or more restrictions to be applied to the transaction based on the flag. The steps further include generating an authorization response message. The authorization response message includes a payload in view of the one or more restrictions. The steps further include transmitting, to the resource provider computer, the authorization response message including the payload. The resource provider computer performs at least one of: when the payload includes one or more prompts, displays the one or more prompts on a terminal, receives input in response to the one or more prompts, generates a clearing message including the input in response to the one or more prompts, such that the clearing message is transmitted to the issuer computer, or when the payload includes one or more rules, processes the items in the transaction based on the one or more rules.

### BRIEF DESCRIPTION OF THE DRAWINGS

FIG. 1 illustrates a system and a block diagram for applying a control to a fleet-based transaction, according to various embodiments.

FIG. 2 illustrates an example sequence for applying host-based purchase restrictions in a fleet-based transaction, according to various embodiments.

FIG. 3 illustrates a process for implementing host-based prompting in a fleet-based transaction, according to various embodiments.

FIG. 4 illustrates a process for applying host-based restrictions to transactions using line item approvals via host authorizations, according to various embodiments.

FIG. 5 depicts an example flowchart for a process performed by an issuer computer to apply host-based controls for fleet-based transactions, according to various embodiments.

FIG. 6 depicts an example flowchart for a process performed by a resource provider computer to apply host-based controls for fleet-based transactions, according to various embodiments.

FIG. 7 depicts a computer system for implementing various embodiments.

### DETAILED DESCRIPTION OF THE INVENTION

Embodiments are related to enabling dynamic, issuer-directed restrictions on purchase transactions conducted using fleet cards, commercial accounts, or similar payment instruments. In this context, a purchase restriction refers to any rule, instruction, or limitation provided by an issuer that governs whether particular goods or services in a transaction may be approved, denied, or otherwise conditioned as part of the payment process. Such restrictions may address categories of goods (e.g., allowing the purchase of fuel but not alcohol), item-level approvals, price limitations, or other eligibility criteria. A resource provider refers to a merchant, retailer, or other entity that accepts payment on behalf of an organization or fleet operator. In various implementations, a resource provider computer may transmit an authorization request message to an issuer computer, including a flag indicating the ability to support issuer-directed restrictions. The issuer computer may then generate an authorization response message including a payload, such as a set of purchase restrictions (e.g., prompts and/or rules) which enables the resource provider to process the transaction according to issuer policy. This approach allows for flexible, real-time enforcement of transaction rules, supporting adaptive risk management, operational controls, and cost optimization. For example, a fleet operator may use purchase restrictions to prevent purchases of non-business-related items or to implement region-specific controls without issuing new cards to users.

In some embodiments, the transaction may be a card-not-present transaction, initiated using a digital credential uploaded to a mobile application running on a user device or a card-on-file account. The authorizing entity (e.g., issuer, host) can send prompts for information. The resource provider receives, and/or calculates inputs, and transmits inputs on new fields. Resource providers indicate, via a flag in the authorization request message, what controls they can support at their terminal. Upon checking this flag, issuers send back a set of host-based purchase restrictions in the authorization response message to override the chip-based purchase restrictions (if applicable) or to add host-based prompting requirements. This allows an issuer to have dynamic control of the purchase and only allow the restriction they are passing back. The issuer can dynamically change the type of rules (e.g., what category of products may be purchased.).

Embodiments relate to a processing system for implementing fleet-based rules (e.g., purchase control or restriction) to a purchase (e.g., fleet-based vehicle energy purchase) initiated by a fleet client (e.g., fleet vehicle driver) at a resource provider (e.g., a merchant). An exemplary processing system is described in U.S. patent application Ser. No. 18/589,366, entitled “Fleet-Based Merchant Purchase control or restriction System and Method Therefor”, filed on Feb. 27, 2024, the content of which is incorporated herein by reference for all purposes.

The present invention provides a payment processing system and associated methods for dynamic, host-based enforcement of fleet-based rules, including purchase restrictions, purchase control or restrictions, and required prompts, during transactions that may involve more than ten items at a merchant terminal. In contrast to conventional systems in which such rules are statically encoded on a payment card, the rules described herein may be enforced by the issuer (“host”) and/or the resource provider at the time of authorization, based on real-time transaction context and merchant terminal capabilities.

Traditionally, fleet-based rules (e.g., purchase controls or prompts) are programmed on chip cards (e.g., EMV payment card) that are distributed to the fleet members. When the fleet member presents the card during a transaction (e.g., gas purchase), the fleet member is prompted with questions as programmed on the chip card (e.g., driver ID, etc.). However, where the rules are modified, new chip cards need to be issued and distributed to the fleet members. This results in delays, and is not ecologically friendly as it results in additional plastic cards being issued, and old plastic cards being disposed in landfills. In addition, existing techniques are not applicable to card-not-present (e.g., digital or card-on-file) transactions. That is, fleet-based rules (e.g., prompting and purchase restrictions) currently cannot be programmed to digital cards or card-on-file accounts. For example, in an exemplary EV charging implementation, the EV charging service provider charging station may require an account to be generated for the driver or the vehicle, and a payment method to be stored in that account. Existing methods do not allow for the issuer or the processing environment (e.g., including a processing server) to apply rules or request additional information about a payment method stored on a wallet of the EV charging service provider. In addition, some existing systems allow for processing a limited number of items (e.g., 10) in a transaction using a fleet-based account due to the restriction of amount of data that can be sent using a conventional authorization request message from a merchant terminal to an issuer.

Embodiments provide host-based prompting to allow the issuers ask for information as part of an authorization response message during a transaction initiated either with (1) a chip card (programmed with a first set of rules, but the issuer wants to implement a second set of rules), or (2) digital or card-on-filed accounts. The issuer requests the information, and the merchant prompts for the information on a terminal (e.g., pump screen, POS device, etc.). When the issuer approves a transaction, the issuer may also indicate in the authorization response message that while the transaction is approved, the data identified in this authorization response message should be captured for the transaction.

In certain implementations, the payload delivered by the issuer computer may include one or more prompts, which are instructions to the resource provider computer to collect specific supplemental data from a user at the point of sale. Host-based prompting enables the issuer computer to dynamically request information such as driver identification, vehicle identification, odometer readings, or trip details during the transaction, regardless of whether such prompts were pre-configured on a physical payment card. Host-based prompting provides the advantage of real-time adaptability, allowing the issuer computer to request additional data when business rules, compliance obligations, or potential fraud risks require it. For instance, a fleet manager may decide to collect driver identification only for certain types of purchases, at certain locations, or during particular time periods. The ability to encode and deliver such prompts as part of the authorization response message permits organizations to enhance accountability, facilitate detailed reporting, and support regulatory requirements, all without the need to reissue or physically update payment cards.

Further, the described techniques allow for the resource provider to request authorization for more than a predetermined number of items (e.g., more than 10 items) in a transaction using host-based controls. In some embodiments, the fleet-based rules provided by the host (e.g., issuer) may be applicable to a preset type of goods (e.g., fuel, food, but no alcohol or clothing). For a transaction including more items than the predetermined number (e.g., more than 10 items), the resource provider may list a few items (e.g., up to 10) in the authorization request message (e.g., as ISO data set 1A), and insert a flag in the authorization request message indicating that there are more items in the transaction. The items listed in the authorization request message (e.g., as ISO data set 1A) are those that fall under a pre-determined category (e.g., energy related purchase, such as fuel or electric power). No items under other categories (e.g., food, clothing, alcohol) may be listed in the authorization request message. The flag in the authorization request message signals to the issuer to provide the host-based controls (e.g., fleet-based rules) to the resource provider so that the rules can be applied to remaining items (e.g., those that were not listed in the authorization request message) in the transaction in real time.

The resource provider may provide a complete list of items in the transaction to the issuer during the clearing and settlement process.

In some embodiments, an entity (e.g., a consumer, a fleet account holder) can initiate a transaction with a resource provider (e.g., a resource provider computer) for a number of items using an account issued by an issuer. The account may be a fleet-based account that is associated with a special purchase control or restriction for energy (e.g., fuel or electric power) charges. For example, a fleet driver may initiate a transaction for purchasing gas, food, and alcoholic beverage at the merchant (e.g., a gas station). The total number of items in the transaction may be more than the predetermined threshold (e.g., 10 items) conventionally authorized in transactions using the fleet-based account. The resource provider may generate an authorization request message including a flag indicating that items in the transaction surpasses the predetermined threshold.

Upon receiving the authorization request message with the flag, the issuer (e.g., issuer computer) may identify the host-based controls (e.g., one or more rules) applicable to the transaction, the resource provider and/or the account used in the transaction. The issuer may then generate an authorization response message including the host-based controls. The issuer may transmit the authorization response message to the resource provider. The resource provider may process the transaction in real time for the items based on the host-based controls. For example, in view of the host-based controls, part of the items (e.g., fuel/electric power) may be processed with a purchase control or restriction, food may be processed as an allowed item, and the alcoholic beverage may not be processed at all (e.g., not allowed by the host-based controls.) When the total number of items in the transaction is more than the predetermined threshold (e.g., 10 items), the resource provider may include a subset of the items in the authorization request message. For example, the merchant may provide a list of items that fall in a pre-approved category of the issuer (e.g., fuel/electric power) in the authorization request message. The authorization response message may include authorization indication for such items. At a later time (e.g., as part of the clearing process), the resource provider may provide to the issuer the entire list of items in the transaction. In some systems, this may be achieved using Level 3 data or additional record types, which allow for the transmission of hundreds or thousands of line items. The issuer then confirms that the transaction was processed in compliance with the host-based rules supplied during authorization.

In some embodiments, if the authorization request message also includes not authorized items (e.g., alcoholic beverage), the authorization response message from the issuer may simply exclude such items, therefore indicating that the issuer did not authorize the transaction for those items.

Prior to discussing embodiments of the disclosure, some terms can be described in further detail.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “transaction” may be any interaction or exchange between two or more parties. For example, a transaction may include a first entity requesting resources from a second entity. In this example, the transaction is completed when the resources are either provided to the first entity, or the transaction is declined. An example transaction is a payment transaction.

An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “resource provider” may be an entity that can provide a resource such as goods, services, information, and/or access to a location (e.g., a parking space, a transit terminal, etc.). Examples of resource providers include merchants, governmental authorities, secure data providers, etc.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

A “processing server” may include data processing subsystems, networks, and operations. In embodiments, a processing server may be used to support and deliver authorization services, exception file services, and clearing and settlement services. A processing server may be a payment processing network able to transmit and receive financial system transaction messages (e.g., ISO 8583 messages), and process original credit and debit card transactions. An exemplary payment processing system may include VisaNet™ Payment processing systems such as VisaNet™ are able to process credit card transactions, debit card transactions, and other types of commercial transactions.

An “authorization request message” may be a message that requests permission to conduct an interaction. For example, an authorization request message may include an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. The authorization response message can be generated by an issuing financial institution or a payment processing network. The authorization response message may include, by way of example only, one or more of the following status indicators:

Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant computer that indicates approval of the transaction. The code may serve as proof of authorization. As noted above, in some embodiments, a payment processing network may generate or forward the authorization response message to the merchant.

A “flag” or “purchase restrictions flag” may refer to a data field or value included in an authorization request message, set by a resource provider computer, that indicates the capability of the resource provider to support one or more types of restrictions or prompting requirements for a transaction. The flag may specify, for example, support for chip-based purchase restrictions, host-based purchase restrictions, host-based prompting, or the ability to process transactions including more than a predetermined threshold number of items.

A “payload” may refer to the portion of an authorization response message sent by an issuer computer to a resource provider computer, the contents of which specify one or more rules, one or more prompts, or other transaction controls to be applied in processing the transaction.

A “prompt” may refer to a directive, instruction, or message provided by an issuer computer to a resource provider computer or terminal, requesting the collection of supplemental transaction data from an entity at the point of sale. Prompts may include requests for driver identification, vehicle identification, odometer readings, or other data. In some embodiments, each prompt may be encoded using a predetermined byte structure, such as a two-byte format specifying prompt type, data type (numeric or alphanumeric), required/optional status, and additional attributes (e.g., print on receipt, manual entry allowed, entry in the clear).

A “rule” may refer to any instruction, policy, or limitation provided by an issuer computer that governs the approval, denial, price, quantity, or eligibility of goods or services within a transaction. Rules may apply at the item level (e.g., approve or deny specific items, such as brand X cookies, using product codes), product category level (e.g., allow fuel but not alcohol as a product category), or transaction level (e.g., maximum total amount, minimum required input).

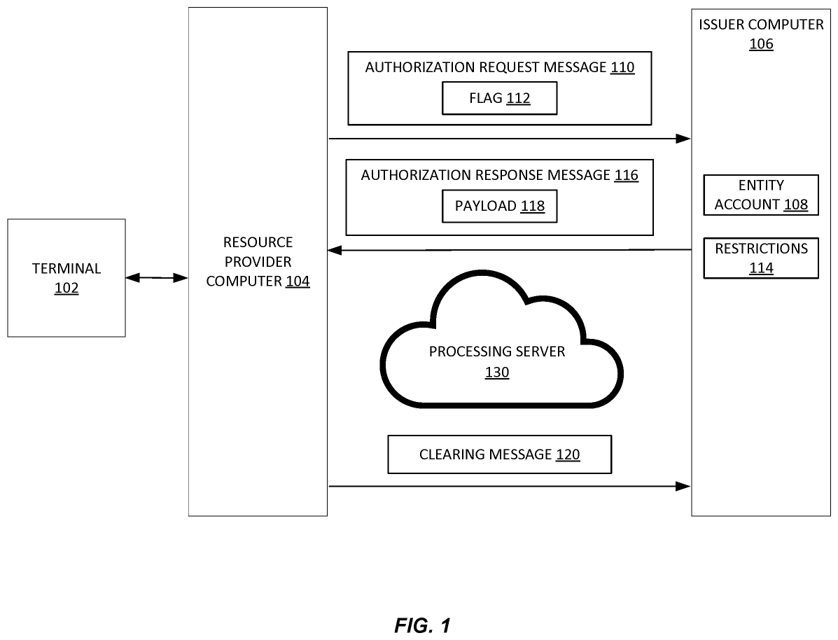

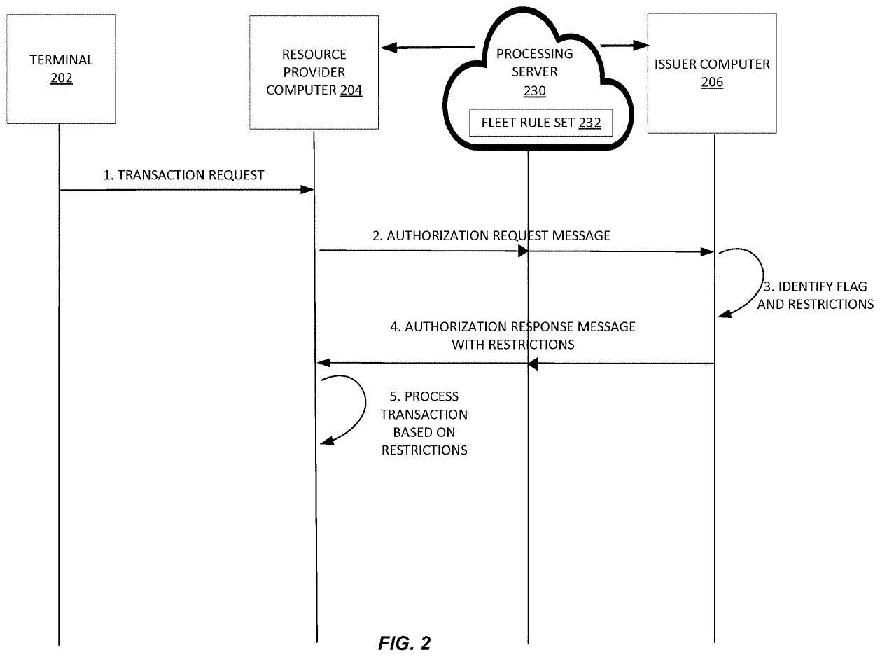

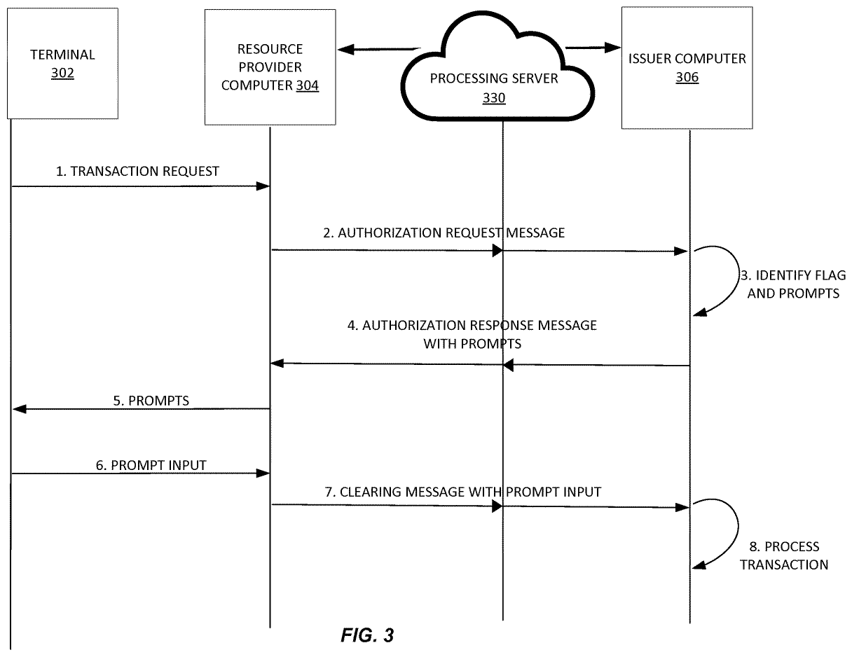

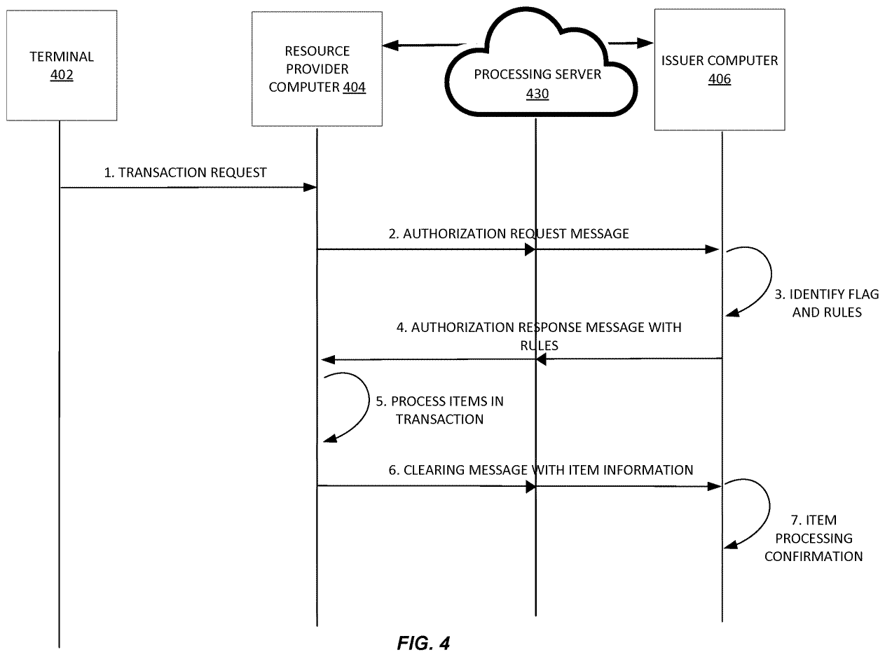

FIG. 1 illustrates a system and a block diagram for applying a control to a fleet-based transaction, according to various embodiments. Each of the entities in FIG. 1 (as well as FIG. 2, FIG. 3 and FIG. 4) may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

A terminal 102 is operated by an entity, such as an employee, driver, or other authorized user, to conduct a transaction with a resource provider. The terminal 102 is in communication with a resource provider computer 104, which is operated by or on behalf of the resource provider, such as a merchant, retailer, or service location. The resource provider computer 104 is further in communication with a processing server 130 that can receive, process and relay messages to the resource provider computer 104 via an acquirer. The processing server 130 can also receive, process and relay messages to an issuer computer 106 associated with an issuer of payment accounts, such as a bank, fleet operator, or commercial account provider. The entity possesses an entity account 108 with the issuer, which is issued by the issuer and may be embodied as a fleet card, commercial card, or other payment instrument.

The terminal 102 enables the entity to initiate a transaction involving one or more items, such as fuel, vehicle fluids, maintenance parts, food, or other goods and services. The terminal 102 may be located at a retail fuel location, convenience store, service center, or other point of sale, and may include a user interface for input and display, a card reader, or connectivity for digital wallet or mobile payment scenarios.

When the transaction is initiated, the resource provider computer 104 transmits an authorization request message 110 to the processing server 130, which then identifies the recipient as the issuer computer 106 and relays the authorization request message 110 to the issuer computer 106. The authorization request message 110 includes a flag 112 that indicates the resource provider's capability to support issuer-directed restrictions for the transaction. The flag 112 may take on various values to signal different supported restrictions. For example, the flag 112 may indicate support for chip-based purchase restrictions (e.g., restrictions encoded on a physical card), support for host-based purchase restrictions (e.g., issuer-supplied rules delivered in an authorization response message), support for both chip-based and host-based restrictions, support for host-based prompting (e.g., instructions to collect supplemental data from the user), support for transactions involving more than a predetermined threshold of items (e.g., more than 10 line items), and/or any other suitable supported restrictions.

In some examples, the issuer computer 106 can receive the authorization request message 110 and review the flag 112 to identify the restriction supported by the resource provider. Based on the flag 112, the issuer computer 106 identifies restrictions 114 to be applied to the transaction. Restrictions 114 may include item-level rules, category-based approvals or denials, price limitations, or requirements to collect supplemental data from the user.

Upon determining the restrictions 114, the issuer computer 106 can generate an authorization response message 116 that includes a payload 118 in view of the restrictions 114. The payload 118 may include one or more rules specifying which items are approved or denied, price adjustments, or category limitations. The payload 118 may also include one or more prompts, such as instructions to collect driver identification, vehicle identification, odometer readings, or other transaction-specific data. The issuer computer 106 can transmit the authorization response message 116 to the processing server 130, that identifies the resource provider computer 104 as the recipient and transmits the authorization response message 116 to the resource provider computer 104 via the acquirer.

Upon receiving the authorization response message 116, the resource provider computer 104 processes the transaction according to the payload 118. For example, when the payload 118 includes prompts, the resource provider computer 104 can display the prompts on the terminal 102, receive input from the entity, and generate a clearing message 120 that includes the collected input. The clearing message 120 may include additional information and a request for the processing server 130 to process clearing and settlement between the financial institution of the resource provider and the issuer. The processing server 130 may receive the clearing message 120 and transmit the clearing message to the issuer computer 106, enabling supplemental data collection for compliance, reporting, or fraud prevention. Alternatively, when the payload 118 includes rules, the resource provider computer 104 can process the items in the transaction based on the rules, such as approving fuel purchases while denying alcohol or other unapproved items, and can generate a clearing message 120 reflecting the completed transaction.

In some examples, the clearing message 120 is sent from the resource provider computer 104 to the processing server 130 via an acquirer, and then from the processing server 130 to the issuer computer 106, providing a full record of the transaction, including item-level details, supplemental data, and compliance with issuer-supplied restrictions. The described system supports a range of operational scenarios, including card-present and card-not-present transactions, dynamic restriction updates, and large multi-item purchases. For example, a fleet operator may allow approval of all fuel and maintenance fluids in a single transaction while excluding unrelated retail goods, or may prompt for driver identification only at specific locations or times. The described system enables flexible, real-time control over purchase activity, robust data collection, and adaptive business logic.

FIG. 2 illustrates an example sequence for applying host-based purchase restrictions in a fleet-based transaction, according to various embodiments. A terminal 202, which is an example of the terminal 102 in FIG. 1, is operated by an entity to initiate a transaction with a resource provider. The terminal 202 may be located at a fuel dispenser, convenience store, service center, or another point of sale, and may support a range of user interfaces and payment modalities, including card-present and card-not-present transactions. The terminal 202 can receive transaction details from the entity, such as a list of items to be purchased, and communicates a transaction request to a resource provider computer 204 in a first step. The resource provider computer 204 is an example of the resource provider computer 104 in FIG. 1.

In a second step, the resource provider computer 204 can receive the transaction request from the terminal 202 and prepare an authorization request message for submission to an issuer computer 206, which is an example of the issuer computer 106 in FIG. 1, through a processing server 230, which is an example of the processing server 130 in FIG. 1. The authorization request message can include a flag indicating the resource provider's capability to support issuer-directed restrictions for the transaction. As part of the authorization request message, the resource provider computer 204 can set the flag as various values in a dedicated field (e.g., Field 125, dataset 6B, tag 0D). This flag communicates to the issuer computer 206 which types of restrictions and prompting the terminal and acquirer chain are capable of supporting. For example, the flag may be set to one of the following values:
A first value such as Zeros, $Null, Spaces or Other Values corresponds to no restrictions being supported. So, the merchant or acquirer does not support chip-based purchase restrictions nor host-based purchase restrictions. This implies that the merchant cannot support chip-based or host-based purchase restrictions.
A second value such as 1 corresponds to chip-based restrictions, where the merchant can support the chip-based (e.g., DF32) restrictions on the chip card. The merchant/acquirer chain cannot support purchase restrictions coming back from the host. This implies that the merchant can only apply purchase restrictions as set on the card.
A third value such as 2 corresponds to host-based restrictions, where the merchant/acquirer chain can receive the host-based purchase restrictions (e.g., at the EMV pump or in-store) coming back in the authorization response message. The chip restrictions are not considered at all, and the merchant will consider the host-based restrictions only. This implies the merchant can only apply host-based purchase restrictions returned as part of an online message.
A fourth value such as 3 corresponds to both chip-based and host-based restrictions, where the host-based restrictions override the restrictions on the chip of the card. This is a fully compliant fleet solution that can handle both host-based and chip-based purchase restrictions.
A fifth value such as 4 corresponds to host-based prompting and host-based purchase restrictions, where the resource provider supports both host-based purchase restrictions and host-based prompting (e.g., issuer instructions to collect supplemental data from the user in real time).
A sixth value such as 5 corresponds to both chip-based and host-based prompting and purchase restrictions, meaning that the resource provider supports chip-based and host-based restrictions and prompting, allowing host-based controls and prompts to supplement or override chip-based controls.
A seventh value such as 6 corresponds to a transaction that includes greater than a threshold number of items. This means that the resource provider supports transactions involving more than a predetermined threshold number of items (e.g., more than 10 items in a single transaction), enabling the issuer to provide rules or instructions for handling large, complex purchases.

In a third step, upon receiving the authorization request message through the processing server, the issuer computer 206 can review the flag to determine the restriction capabilities of the resource provider. The issuer computer 206 then identifies one or more restrictions to be applied to the transaction, which may include item-level rules, category-based restrictions, price controls, or other eligibility criteria. These restrictions may be determined based on issuer policy, account status, transaction context, or other business logic.

In a fourth step, the issuer computer 206 can generate and transmit an authorization response message that includes the identified restrictions. The restrictions may be included as part of a payload in the authorization response message, specifying which items are approved or denied, any applicable price adjustments, or category limitations for the transaction. The payload can be included in a dedicated field (e.g., Field 125, dataset 6B, tag 0E) of the authorization response message to override the chip-based purchase restrictions (e.g., tag ‘DF32’). This field allows the issuer computer 206 to specify which items or categories of items are approved, denied, or subject to particular price or quantity constraints. For example, the host-based purchase restrictions may authorize only purchases of fuel or maintenance fluids, while excluding other retail products. This allows an issuer computer 206 to have dynamic control of the purchase and only allow the restriction they are passing back. The authorization response message is transmitted from the issuer computer 206 to the processing server, which then identifies the resource provider computer 204 and transmits the authorization response message to the resource provider computer 204.

Upon receiving the authorization response message, in a fifth step, the resource provider computer 204 can process the transaction according to the restrictions specified in the payload. This may include allowing only approved items to be purchased, excluding denied items from the transaction, or enforcing price limitations or category-specific controls at the point of sale. For example, the resource provider computer 204 may approve all energy or fuel and maintenance fluids in a transaction while excluding unrelated retail goods, or enforce region-specific restrictions based on issuer policy. If the host-based controls dictate that purchase of alcoholic beverages is not allowed, the resource provider computer 204 will not process the sale of the alcoholic beverages using the card issued by the issuer. The entity may use a different account for such purchase. The resource provider computer 204 may enforce these controls by permitting only the approved items to be completed in the transaction and declining or prompting for an alternative payment method for non-approved items. The resource provider computer 204 may apply the purchase control or restriction in real time. The resource provider computer 204 may then complete the transaction with the entity and may generate a clearing message including the details of the processed transaction for subsequent settlement with the issuer computer 206.

The clearing message generated after transaction completion can include a full itemized list of all purchased items, enabling the issuer computer 206 to verify compliance with the host-based controls during settlement and reconciliation.

In various examples, a processing server 230 may store a fleet rule set 232 (e.g., a discount plan) and may apply the rules to eligible transactions, such as transactions that satisfy one or more predetermined criteria (e.g., an energy or fuel transaction), based on information provided by the resource provider or the entity in the authorization request message transmitted for a particular transaction. The fleet rule set 232 may include a discount plan that is initiated and driven by the issuer or another financial entity, or a discount plan that is initiated and driven by the resource provider.

In various operational models, such as pre-pay and post-pay, the host-based purchase restrictions may be applied at different stages of the transaction. For instance, in a pre-pay scenario, the authorization may take place before the final transaction amount is known, and confirmation or completion advice messages may be used to finalize the transaction and apply any applicable discount or control fields. In a post-pay model, the resource provider computer 204 may transmit the final transaction amount and itemization in the authorization or clearing messages, and the issuer computer 206 may return restriction information for settlement.

In the U.S. Region, a pre-authorization can take place for a $1 Status Check (e.g., automated fuel dispenser) or an authorization can take place for a standard authorization amount (e.g., in-store payment for fuel or energy transaction). When the final transaction amount is known, the resource provider computer 204 can submit a confirmation advice message or a completion advice message with detailed information about the transaction to enable the processing server 230 to calculate the discount. The processing server 230 can add any applicable discount-related fields to the advice message and send it to the issuer computer 206. The issuer computer 206 can respond according to its standard processing rules and the processing server 230 can add the discount-related fields before sending the response message to the resource provider computer 204 via the processing server 230. If the transaction does not contain the fields or values required for the processing server 230 to calculate the discount, the processing server 230 can process the transaction according to standard processing rules.

In a pre-pay model, if a merchant needs to reverse a confirmation advice message with a reversal message, the merchant may be required do a full reversal on the discounted amount that was sent back on the confirmation response message from the processing server 230. A partial reversal in this situation is not supported given the issuer computer 206 would not know exactly what to reverse with discounts.

In a post-pay model (e.g., in the European Region), the final transaction amount is known, (e.g., the fuel is pumped or the battery is charged, and then the payment is submitted). The resource provider computer 204 can generate and transmit an authorization request message with the final amount. The processing server 230 can then apply the discount information based on the details in the portal and update the authorization request message and send to the issuer computer 206. The resource provider computer 204 can then clear the transaction after receiving the authorization response message from the processing server 230 with the updated discount information. According to some embodiments, in the post-pay model, host-based prompting may be indicated (e.g., the issuer may request the additional information) in the clearing message.

An estimated authorization can take place for a standard authorization amount at the automated fuel dispenser. When the final transaction amount is known, the resource provider computer 204 can submit a confirmation advice message or a completion advice message with detailed information about the transaction to enable the processing server 230 to calculate the discount. The processing server 230 can add any applicable discount-related fields to the advice message and send it to the issuer computer 206. The issuer computer 206 can respond according to its standard processing rules and the processing server 230 will add the discount-related fields before sending the response message to the resource provider computer 204. If the transaction does not contain the fields or values required for the processing server 230 to calculate the discount, the processing server 230 can process the transaction according to standard processing rules. A discount can be provided on a post-pay authorization request message when the final amount is known or on a confirmation/completion advice message where the final amount is known for all energy transactions (e.g., including transactions for gasoline or electricity).

In a post-pay model as described above, if a merchant needs to reverse a post-pay authorization, the resource provider must do a full reversal on the discounted amount that was sent back on the authorization response message from the processing server 230. A partial reversal in this situation is not supported given the issuer computer 206 would not know exactly what to reverse with discounts.

If no authorization/confirmation response for some reason is not received by the resource provider, then the resource provider computer 204 would send the original pre-discounted amount to the processing server 230, which would pass that along to the issuer computer 206. The issuer computer 206 must recognize, reconcile and reverse the transaction for the amount they have. A partial reversal in this situation is not supported given the issuer computer 206 would not know exactly what to reverse with discounts.

The processing server 230 can implement authorization and confirmation messages (e.g., 0100 and 0200 type ISO 8583 messages) for post pay transactions including partial authorizations where only part of a transaction is approved. In addition, the processing server 230 can implement pass through tags received from the issuer in dedicated fields such as those for transaction-specific data in a particular format (e.g., type-length-value (TLV)) format, fleet line item details, and commercial card IDs (fuel transactions) to the acquirer for specific fleet processes. The processing server 230 can also expand usage of a field associated with non-fuel items for non-fuel goods and services.

In some examples, if an issuer did not put any chip-based purchase restrictions on the card (no restrictions), the issuer may utilize host-based purchase restrictions with capable resource providers to restrict purchases until they can re-issue a card.

FIG. 3 illustrates a process for implementing host-based prompting in a fleet-based transaction, according to various embodiments. A terminal 302, which is an example of the terminal 102 in FIG. 1 is operated by an entity such as an employee, driver, or authorized user.

The terminal 302 may be a fuel dispenser, point-of-sale device, or other transaction interface. In a first step, the terminal 302 can receive a transaction request from the entity, which may include information identifying items to be purchased, and communicate the transaction request to a resource provider computer 304, which is an example of the resource provider computer 104 in FIG. 1. The resource provider computer 304 may be operated by or on behalf of a merchant, retailer, or service provider and is configured for communication with both the terminal 302 and an issuer computer 306, which is an example of the issuer computer 106 in FIG. 1. Messages are received by a processing server 330 from either the resource provider computer 304 or the issuer computer 306 and are routed by the processing server 330 to the relevant recipient (e.g., the resource provider computer 304, an acquirer, or the issuer computer 306). The processing server 330 is an example of the processing server 130 in FIG. 1.

In a second step, the resource provider computer 304 can generate and transmit an authorization request message to the issuer computer 306. The authorization request message can include a flag indicating the resource provider's capability to support host-based prompting. The flag may be set as described above (e.g., a value of 4 or 5 in a designated field such as Field 125, dataset 6B, tag 0D) to signal support for receiving and displaying issuer-supplied prompts at the point of sale.

In a third step, the issuer computer 306 can receive the authorization request message, review the flag, and identify one or more prompts to be delivered to the entity. The prompts may be determined based on issuer policy, account status, transaction context, compliance requirements, or fraud prevention logic. Examples of prompts include requests for driver identification, vehicle identification, odometer readings, or trip information. In some implementations, each prompt is encoded using a predetermined byte structure that allows for compact and efficient transmission.

In some implementations, host-based prompts can be encoded using a two-byte structure for each prompt, allowing for efficient transmission of multiple prompts within a single message. The first byte may specify the type of prompt (e.g., driver ID or vehicle ID), whether the prompt is numeric or alphanumeric, and whether entry is mandatory or optional. The second byte may specify additional attributes, such as whether manual entry is allowed, whether the value should be printed on the receipt, and whether the value should be entered in the clear. For example, the bit pattern ‘00100’ in the first byte may indicate a driver ID prompt, with associated bits indicating data type and required status. This structure enables the issuer computer 306 to deliver up to four prompts in an eight-byte field, expanding the number of prompts supported relative to conventional three-byte chip-based formats.

In a fourth step, the issuer computer 306 can generate an authorization response message including the encoded prompts and transmits this authorization response message to the resource provider computer 304. The prompts can be included in a dedicated field of the authorization response message, such as bytes 9-16 of Field 125, dataset 6B, tag 0E. This dedicated area allows for the dynamic and standardized delivery of prompt instructions to the resource provider computer 304.

In a fifth step, the resource provider computer 304 can display the prompts on the terminal 302, presenting each request to the entity for input. The terminal 302 may render prompts as text, selection menus, or data entry fields, depending on the prompt type and configuration received from the issuer computer 306.

In a sixth step, the resource provider computer 304 can receive input from the entity in response to each prompt. For example, the entity may enter a driver identification number, vehicle ID, or odometer reading as requested. The resource provider computer 304 collects these inputs and prepares them for inclusion in subsequent transaction processing messages.

In a seventh step, the resource provider computer 304 can generate a clearing message including the collected prompt inputs and can transmit the clearing message to the issuer computer 306. The clearing message may be formatted according to payment network protocols and may include all itemized transaction data, prompt responses, and any additional information required for settlement or compliance verification.

In an eighth step, the issuer computer 306 can process the transaction based on the input received in the clearing message. The issuer computer 306 may use the prompt inputs for fraud prevention, regulatory compliance, expense management, or reporting purposes. For example, the issuer computer 206 may verify that the driver identification matches authorized personnel or that the odometer reading is consistent with expected vehicle usage. Processing the transaction in view of the prompt inputs enables enhanced security, accountability, and operational insight.

In various implementations, the described host-based prompting process enables issuers to dynamically adapt data collection requirements in real time, without the need to reissue or update physical payment cards. Prompts may be encoded efficiently to maximize the number of prompts deliverable in a single message and to support a range of business and compliance use cases. For example, a fleet operator may choose to prompt for odometer readings only at certain locations, or require vehicle ID entry for large fuel purchases, thereby enabling flexible, context-driven transaction management.

FIG. 4 illustrates a process for applying host-based restrictions to transactions using line item approvals via host authorizations, according to various embodiments. A terminal 402 (e.g., terminal 102 in FIG. 1) is operated by an entity such as an employee or driver to initiate a transaction with a resource provider. The terminal 402 may be a point-of-sale device, fuel dispenser, or other transaction interface capable of capturing item-level details and communicating with a resource provider computer 404, which is an example of resource provider computer 104 in FIG. 1.

In step 1, the terminal 402 receives a transaction request from the entity, which may include a list of items to be purchased or selected at the point of sale. The terminal 402 communicates this transaction request to the resource provider computer 404. The resource provider computer 404 aggregates the item-level data, such as product codes, quantities, and prices, and prepares an authorization request message for submission to an issuer computer 406, which is an example of the issuer computer 106 in FIG. 1. Messages are received by a processing server 430 from either the resource provider computer 404 or the issuer computer 406 and are routed by the processing server 430 to the relevant recipient (e.g., the resource provider computer 404, an acquirer, or the issuer computer 406). The processing server 430 is an example of the processing server 130 in FIG. 1.

In step 2, the resource provider computer 404 transmits the authorization request message to the issuer computer 406. The authorization request message includes information identifying the items to be purchased in the transaction. In some examples, the authorization request message may include a flag in a designated field (e.g., Field 125, dataset 6B, tag 0D) that indicates whether the transaction includes more than a predetermined threshold number of items (e.g., more than 10 line items). If the number of items does not exceed the threshold, the authorization request message may provide item-level detail for each item, such as by including a data set with line items, product codes, and quantities. If the number of items exceeds the threshold, the authorization request message may include the flag (e.g., value 6) to signal this condition to the issuer computer 406, and may provide only a subset of items or a summary by category. In addition, the resource provider computer 404 may provide a subset of items (such as up to 10) as line items in the authorization request message, and set the flag to indicate that additional items are present but not individually enumerated.

In step 3, the issuer computer 406 receives the authorization request message and reviews the included item details and/or the flag indicating a large transaction. The issuer computer 406 identifies corresponding rules to be applied to the transaction. These rules may include item-level approvals or denials, category-based restrictions, price limitations, or global eligibility criteria. For transactions where the number of items is below the threshold, the issuer computer 406 may generate rules for each individual item, such as approving or declining specific products, modifying prices, or applying category-based controls. For transactions where the number of items surpasses the predetermined threshold, the issuer computer 406 may return rules at a higher level of abstraction, such as authorizing only certain categories (e.g., all fuel or fluids) or disallowing others (e.g., retail goods, alcohol), rather than decisioning each item individually.

In step 4, the issuer computer 406 generates an authorization response message including the identified rules and transmits the authorization response message to the resource provider computer 404. The rules may be encoded in a dedicated payload field (e.g., Field 125, dataset 6B, tag 0E), and may specify, for example, which items or categories are approved. The authorization response message enables the resource provider computer 404 to process the transaction in real time according to issuer policy, supporting both item-level and category-level enforcement.

In step 5, upon receiving the authorization response message, the resource provider computer 404 can process the items in the transaction based on the rules provided by the issuer computer 406. For itemized transactions, this may include approving only those items or categories allowed by the issuer computer 406, where a subset of the items may not be approved for purchase using the account issued by the issuer, declining non-approved items, or prompting the entity to use a different payment account for ineligible items. For large transactions, the resource provider computer 404 may enforce the global or category-level rules specified in the authorization response message, such as allowing only fuel-related items or restricting the purchase of non-business merchandise. In some cases, the issuer computer 406 may grant a partial approval for a transaction, such that only certain items or categories are permitted and others are denied or require alternative payment.

In step 6, the resource provider computer 404 can generate a clearing message including item-level information for all items in the transaction, and can transmit the clearing message to the issuer computer 406. The clearing message may contain a complete, itemized list, including product codes, quantities, prices, and any supplemental data collected during the transaction, regardless of whether the initial authorization request included all items or only a subset. This clearing message enables the issuer computer 406 to perform post-transaction verification and settlement, confirming that the items in the transaction were processed in accordance with the rules returned in the authorization response message.

In step 7, the issuer computer 406 reviews the clearing message and confirms that the items in the transaction were correctly processed based on the previously-supplied rules. The issuer computer 406 may perform compliance checks, reconcile item-level approvals and denials, and ensure that any price or category restrictions were properly enforced by the resource provider computer 404. This verification ensures robust, auditable control over both standard and large, complex purchases, supporting detailed expense management, regulatory compliance, and operational transparency.

In a particular example for post-pay processing transactions based on host-based controls, if the authorization request message includes two fuel-related items and four non-fuel products (two of which are impermissible items by the issuer such as alcohol and tobacco), the issuer computer 406 may reply with an authorization response message listing the authorized items (e.g., two fuel-related items and two non-fuel products that are among allowed items). The authorization response message may not reference the two impermissible items, thereby indicating that the purchase of the two impermissible items is not authorized. Alternatively, the issuer computer may simply send the host-based controls (e.g., “fuel and food only allowed”) in the authorization response message, leaving to the resource provider to process all items in view of the host-based controls. The outcome would be the same as the processing of the two impermissible items will not be authorized in view of the host-based controls. In a case where the issuer cannot adjust the specifics within the line item (e.g., quantity, price), the issuer computer 406 may return items which they approve and by not returning a specific item, the issuer computer 406 indicates that the purchase of the not returned item is declined.

For pre-pay processing transactions based on host-based controls, the issuer can adjust the specifics within the line item (e.g., quantity, price) in the authorization response message. The issuer computer 406 may return items which they approve and by not returning a specific item, the issuer computer 406 indicates that the purchase of the not returned item is declined.

Accordingly, the embodiments support both pre-pay and post-pay transaction flows. In post-pay scenarios, the issuer lists only authorized items in the authorization response message, implicitly declining non-listed items. In pre-pay scenarios, the issuer can adjust line-item specifics (quantity, price) in the authorization response message. The resource provider processes transactions in real time based on these controls, ensuring compliance and optimizing fleet purchase control or restriction application.

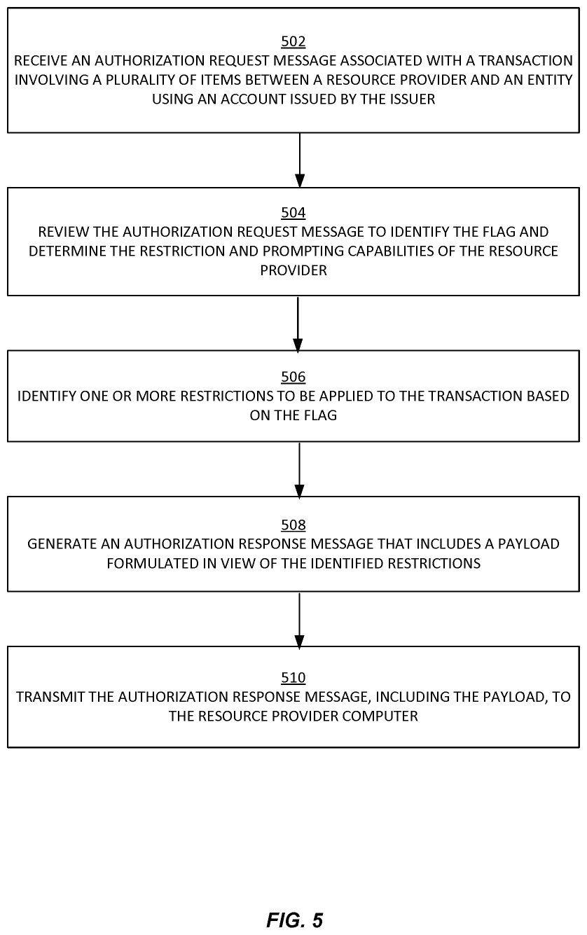

FIG. 5 depicts an example flowchart for a process performed by an issuer computer to apply host-based controls for fleet-based transactions, according to various embodiments. At block 502, the issuer computer of an issuer receives an authorization request message associated with a transaction involving a plurality of items between a resource provider and an entity using an account issued by the issuer. The authorization request message is transmitted from a resource provider computer of the resource provider, which may be a merchant, retailer, or service provider acting on behalf of the entity. The authorization request message includes a flag, for example in a dedicated field, that indicates that the resource provider supports one or more types of restrictions to be applied to the transaction. The flag may specify the resource provider's capabilities, such as support for chip-based restrictions, host-based restrictions, host-based prompting, or the ability to handle transactions exceeding a threshold number of items.

At block 504, the issuer computer reviews the authorization request message to identify the flag. The issuer computer parses the flag value to determine whether it should deliver chip-based, host-based, or both types of restrictions, or if it should provide prompts or category-level controls. By interpreting the flag, the issuer computer ensures that the restrictions or prompts it generates are compatible with the resource provider's infrastructure and the specific transaction context.

At block 506, the issuer computer identifies one or more restrictions to be applied to the transaction based on the flag. These restrictions may include item-level rules (e.g., approving or denying specific products), category-based controls (e.g., permitting only fuel or maintenance items), price limitations, or eligibility criteria based on account status or transaction context.

Alternatively, the restrictions may include prompting requirements, such as instructions to collect supplemental data from the user at the point of sale. The issuer computer may use a combination of internal policy, risk assessment, compliance requirements, and the contents of the authorization request to determine the applicable restrictions and/or prompts.

At block 508, the issuer computer generates an authorization response message that includes a payload in view of the one or more restrictions. The payload may include one or more rules, one or more prompts, or a combination thereof. For prompts, each may be encoded using a predetermined byte structure (e.g., a two-byte format indicating prompt type, data type, required/optional status, and other attributes), supporting the efficient transmission of multiple prompts. For rules, the payload may specify which items or categories are approved or denied, any price modifications, or transaction-wide controls.

At block 510, the issuer computer transmits the authorization response message, including the payload, to the resource provider computer. Upon receipt, the resource provider computer processes the payload according to its contents. When the payload includes one or more prompts, the resource provider computer displays each prompt on a terminal, such as a point-of-sale device or fuel dispenser, requesting input from the entity. The terminal receives the input in response to the prompts, such as driver identification, vehicle ID, or odometer reading, collects the responses, and generates a clearing message including the input in response to the prompts. This clearing message is then transmitted from the resource provider computer to the issuer computer, enabling the issuer to process the transaction using the collected data.

Additionally or alternatively, when the payload includes one or more rules, the resource provider computer processes the items in the transaction based on the one or more rules. This may involve approving only certain items, denying others, and/or applying product restrictions. The resource provider computer then generates a clearing message that includes information associated with all items in the transaction and sends the clearing message to the issuer computer to confirm that the items in the transaction have been correctly processed based on the one or more rules.

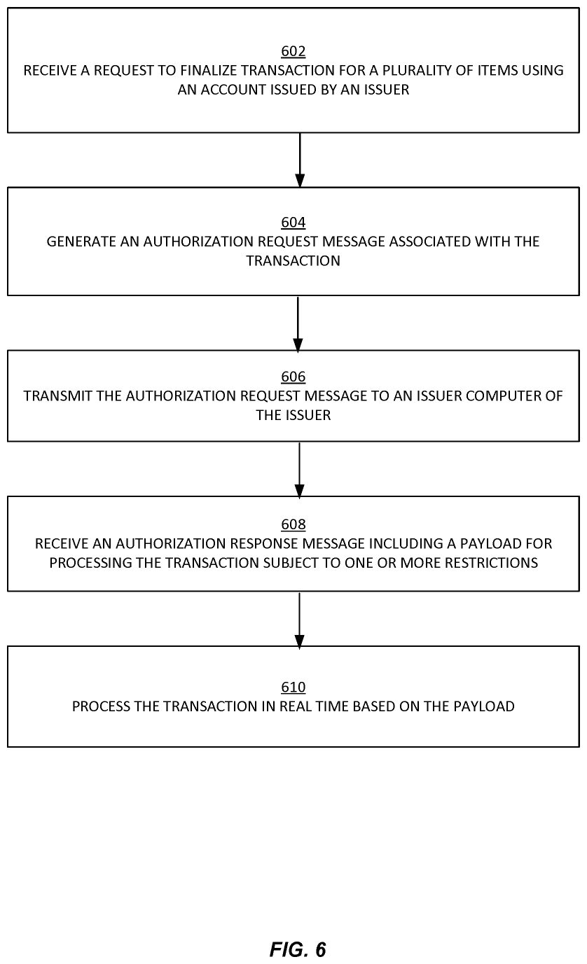

FIG. 6 depicts an example flowchart for a process performed by a resource provider computer to apply host-based controls for fleet-based transactions, according to various embodiments. At block 602, the resource provider computer receives a request to finalize a transaction for a plurality of items using an account issued by an issuer. The request may originate from a terminal operated by an entity, such as an employee or driver, and may include a list of items to be purchased at a point of sale, fuel dispenser, service center, or other transaction interface. The resource provider computer aggregates the item-level data, such as product codes, quantities, and prices, and determines that payment authorization is required to complete the transaction. In some cases, the transaction may include more items than can be individually itemized in a single authorization message.

At block 604, the resource provider computer generates an authorization request message associated with the transaction. The authorization request message includes a purchase restrictions flag in a dedicated field that indicates the resource provider's capability to support issuer-directed restrictions and/or prompts. The flag may specify support for chip-based restrictions, host-based restrictions, host-based prompting, or the ability to handle transactions that surpass a predetermined threshold of items. The authorization request message may include item-level detail for each item, or, if the threshold is exceeded, may include a subset of items (fuel-only) and set the flag to indicate the presence of additional (non-fuel) items.

At block 606, the resource provider computer transmits the authorization request message to an issuer computer of the issuer. The issuer computer receives the authorization request message and processes the information, including the flag value and any item-level or summary data provided.

At block 608, the resource provider computer receives an authorization response message including a payload for processing the transaction subject to one or more restrictions.

The resource provider computer receives the authorization response message from the issuer computer. The payload may consist of one or more rules (e.g., which items or categories are approved or denied), one or more prompts (e.g., instructions to collect driver ID, vehicle ID, odometer reading, or other supplemental data), or a combination thereof. The resource provider computer can interpret the payload, determine the operational logic required for transaction processing, and prepare to enforce the issuer-supplied controls in real time at the point of sale.

At block 610, the resource provider computer processes the transaction in real time based on the payload. When the payload includes one or more prompts, the resource provider computer displays each prompt on a terminal, such as a point-of-sale device or fuel dispenser, soliciting input from the entity. The terminal receives the required input in response to the prompts, such as driver identification, vehicle ID, or odometer reading, collects the responses, and generates a clearing message that includes the input in response to the prompts. The clearing message is transmitted to the issuer computer, enabling the issuer to process the transaction based on the supplemental data collected. The prompts are encoded using a predetermined byte structure, for example, a two-byte format specifying prompt type, data type, and required/optional status, supporting efficient and flexible data collection.

Additionally or alternatively, when the payload includes one or more rules, the resource provider computer processes the items in the transaction based on the rules. This may involve determining whether each item among the plurality of items are approved for purchase based on the one or more rules, approving only certain items, denying others, or applying product restrictions. For transactions that exceed the predetermined item threshold, the rules may operate at the category or summary level, allowing the resource provider computer to process all eligible items while excluding or flagging ineligible ones. The resource provider computer then generates a clearing message that includes information associated with all items in the transaction, whether individually enumerated or summarized, and transmits the clearing message to the issuer computer for settlement and compliance verification.

Embodiments provide various technical advantages such as enabling processing of large, itemized fleet transactions exceeding conventional limits; enabling dynamic, host-based rule enforcement without the need for physical chip card updates; reducing environmental impact by minimizing plastic card issuance; and enhancing merchant flexibility and issuer control in real time.

Embodiments support a number of use cases, including but not limited to: (1) transactions involving multiple types of fuel (e.g., diesel, diesel exhaust fluid, reefer fuel) in a single sale, as is common in trucking and commercial transportation; (2) category-specific controls, in which only certain items (e.g., fuel or food) are eligible for purchase with the fleet account, while others (e.g., alcohol, maintenance items, non-fleet merchandise) are declined or excluded from authorization; (3) enhanced fraud control, through the use of issuer-directed prompts for odometer, vehicle ID, and driver ID, preventing unauthorized use of the fleet account and providing improved tracking for fleet managers; (4) scalable transaction handling, with support for up to 999 items per transaction in clearing and settlement records; and (5) environmental and operational efficiencies, as host-based rules can be updated and enforced dynamically without requiring the re-issuance of physical payment cards.

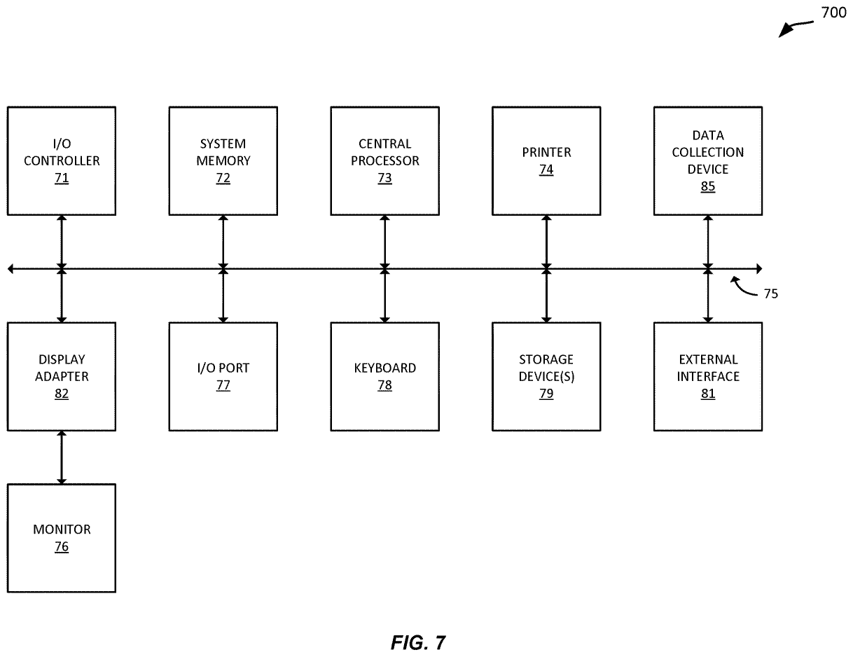

Any of the computer systems mentioned herein may utilize any suitable number of subsystems. Examples of such subsystems are shown in FIG. 7 in computer system 700. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 7 are interconnected via a system bus 75. Additional subsystems such as a printer 74, keyboard 78, storage device(s) 79, monitor 76 (e.g., a display screen, such as an LED), which is coupled to display adapter 82, and others are shown.

Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g., Ethernet, Wi-Fi, etc.) can be used to connect computer system 700 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 can be implemented using any combination of any number of non-volatile memories (e.g., flash memory) and volatile memories (e.g., DRAM, SRAM), or any other non-transitory storage medium, or a combination thereof media. The system memory 72 may store computer code, executable by the central processor 73, for performing any of the functions described herein. The system memory 72 and/or the storage device(s) 79 may embody a computer readable medium. Another subsystem is a data collection device 85, such as a camera, microphone, accelerometer, and the like. Any of the data mentioned herein can be output from one component to another component and/or can be output to a user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 4, 20, 50, 40, 200, 500, 1,000, or 4,000 devices. Methods can include various numbers of communication messages between devices, including at least 40, 200, 500, 1,000, 4,000, 50,000, 40,000, 500,00, or one million communication messages. Such communications can involve at least 1 MB, 10 MB, 100 MB, 1 GB, 10 GB, or 100 GB of data.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present disclosure can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by an issuer computer of an issuer from a resource provider computer of a resource provider, an authorization request message associated with a transaction of a plurality of items between the resource provider and an entity using an account issued by the issuer, the authorization request message including a flag indicating that the resource provider supports a restriction to be applied to the transaction;
reviewing, by the issuer computer, the authorization request message to identify the flag;
identifying, by the issuer computer, one or more restrictions to be applied to the transaction based on the flag;
generating, by the issuer computer, an authorization response message, wherein the authorization response message includes a payload in view of the one or more restrictions; and
transmitting, by the issuer computer to the resource provider computer, the authorization response message including the payload,
wherein the resource provider computer performs at least one of:
when the payload includes one or more prompts, displays the one or more prompts on a terminal, receives input in response to the one or more prompts, generates a clearing message including the input in response to the one or more prompts, wherein the clearing message is transmitted to the issuer computer, or
when the payload includes one or more rules, processes the items in the transaction based on the one or more rules.

2. The method of claim 1, further comprising:
receiving, by the issuer computer, the clearing message; and
processing, by the issuer computer, the transaction based on the input to the one or more prompts.

3. The method of claim 2, wherein the clearing message includes information associated with all items in the transaction; and the method further comprises:
confirming, by the issuer computer, that the items in the transaction have been correctly processed based on the one or more rules.

4. The method of claim 1, wherein the flag indicates that a number of items in the transaction surpasses a predetermined threshold.

5. The method of claim 1, wherein a subset of items in the transaction are not approved for purchase using the account issued by the issuer based on the one or more rules.

6. The method of claim 1, wherein the one or more rules include a product code indicating whether one of the items is approved for processing.

7. The method of claim 1, wherein the authorization request message includes a first set of items that fall under a first category of goods approved by the issuer, wherein the authorization response message includes authorization for the first set of items along with the one or more rules.

8. The method of claim 1, wherein each one of the one or more prompts is encoded using a predetermined byte structure that allows transmission of additional prompts relative to chip-based prompting formats.

9. A method comprising:
receiving, by a resource provider computer, a request to finalize a transaction for a plurality of items using an account issued by an issuer;
generating, by the resource provider computer, an authorization request message associated with the transaction, the authorization request message including a purchase restrictions flag;
transmitting, by the resource provider computer, the authorization request message to an issuer computer of the issuer;
receiving, by the resource provider computer from the issuer computer, an authorization response message, wherein the authorization response message includes a payload for processing the transaction subject to one or more restrictions; and
processing in real time, by the resource provider computer, the transaction based on the payload, wherein processing includes at least one of:
when the payload includes one or more prompts, displaying the one or more prompts on a terminal, receiving input in response to the one or more prompts, generating a clearing message including the input in response to the one or more prompts, wherein the clearing message is transmitted to the issuer computer, or
when the payload includes one or more rules, processing the items in the transaction based on the one or more rules including determining whether each item among the plurality of items are approved for purchase based on the one or more rules.

10. The method of claim 9, wherein the authorization request message includes a first set of items that fall under a first category of goods approved by the issuer, wherein the authorization response message includes authorization for the first set of items along with the one or more rules.

11. The method of claim 9, wherein a subset of items among the plurality of items are not approved for purchase based on the one or more rules.

12. The method of claim 9, wherein the purchase restrictions flag indicates that a number of items in the transaction surpasses a predetermined threshold.

13. A system comprising:
an issuer computer of an issuer, the issuer computer comprising one or more processors and a memory storing instructions that, when executed by the one or more processors, cause the one or more processors to perform steps comprising:
receiving, from a resource provider computer of a resource provider, an authorization request message associated with a transaction of a plurality of items between the resource provider and an entity using an account issued by the issuer, the authorization request message including a flag indicating that the resource provider supports a restriction to be applied to the transaction;
reviewing the authorization request message to identify the flag;
identifying one or more restrictions to be applied to the transaction based on the flag;
generating an authorization response message, wherein the authorization response message includes a payload in view of the one or more restrictions; and
transmitting, to the resource provider computer, the authorization response message including the payload,
wherein the resource provider computer performs at least one of:
when the payload includes one or more prompts, displays the one or more prompts on a terminal, receives input in response to the one or more prompts, generates a clearing message including the input in response to the one or more prompts, wherein the clearing message is transmitted to the issuer computer, or
when the payload includes one or more rules, processes the items in the transaction based on the one or more rules.

14. The system of claim 13, wherein the instructions, when executed by the one or more processors, further cause the one or more processors to perform steps comprising:
receiving the clearing message; and
processing the transaction based on the input to the one or more prompts.

15. The system of claim 14, wherein the clearing message includes information associated with all items in the transaction; and the instructions, when executed by the one or more processors, further cause the one or more processors to perform steps comprising:
confirming that the items in the transaction has been correctly processed based on the one or more rules.

16. The system of claim 13, wherein the flag indicates that a number of items in the transaction surpasses a predetermined threshold.

17. The system of claim 13, wherein a subset of items in the transaction are not approved for purchase using the account issued by the issuer based on the one or more rules.

18. The system of claim 13, wherein the one or more rules include a product code indicating whether one of the items is approved for processing.

19. The system of claim 13, wherein the authorization request message includes a first set of items that fall under a first category of goods approved by the issuer, wherein the authorization response message includes authorization for the first set of items along with the one or more rules.

20. The system of claim 13, further comprising:
the resource provider computer configured to processing in real time the transaction based on the payload, wherein processing includes at least one of:
when the payload includes the one or more prompts, displaying the one or more prompts on the terminal, receiving the input in response to the one or more prompts, generating the clearing message including the input in response to the one or more prompts, wherein the clearing message is transmitted to the issuer computer, or
when the payload includes the one or more rules, processing the items in the transaction based on the one or more rules including determining whether each item among the plurality of items are approved for purchase based on the one or more rules.
